(19) United States
(12) Patent Application Publication
(10) Pub. No.: US 2020/0058040 A1
(43) Pub. Date: Feb. 20, 2020

(54) METHOD AND SYSTEMS TO FACILITATE A USER/MEMBER TO PROCURE PRODUCTS OR INFORMATION FROM ONE OR MORE SELLERS IN THE VICINITY OF THE USER IN REAL TIME

(71) Applicants: Paul J. KANDLE, Somerville, NJ (US); Elia MUSTACCHIA, Raritan, NJ (US)

(72) Inventors: Paul J. KANDLE, Somerville, NJ (US); Elia MUSTACCHIA, Raritan, NJ (US)

(21) Appl. No.: 16/541,899

(22) Filed: Aug. 15, 2019

Related U.S. Application Data
(60) Provisional application No. 62/719,442, filed on Aug. 17, 2018.

(51) Int. Cl. G06Q 30/02; H04W 4/021; H04W 4/029

(52) U.S. Cl. CPC G06Q 30/0201; G06Q 30/0208; H04W 4/029; H04W 4/021

(57) ABSTRACT

Systems and methods for procuring information from nearby devices are provided. The systems and methods may have an online platform hosted on a centralized server and accessible via a computing device and a first device and a second device in communication with at least one of the online platform over at least one first communication network. Further, the systems and methods may have at least one software application that is compatible with the computing device such that online platform creates and processes at least one query based on geographical locations of the at least one first device and the at least one second device corresponding to a search radius starting from a first geographical location of the at least one first device.

This non-provisional application claims priority from U.S. provisional application Ser. No. 62/719,442, filed Aug. 17, 2018, which is incorporated herein by reference in its entirety.

### FIELD OF THE INVENTION

The present invention relates generally to a data processing. More specifically, the present invention is a methods and systems to facilitate a user/member to procure products or information from one or more user/members (sellers) in the vicinity of the user in real time.

### BACKGROUND OF THE INVENTION

Organizations such as e-commerce websites have grown tremendously over the past few years. The major reason behind the huge increase in number of e-commerce users can be related to the customer satisfaction provided by such e-commerce platforms.

A user can now buy any product while sitting at home via the clicks of few buttons. In certain cases, the delivery of product might take 10-12 hours or even a few days. Thus, it is inconvenient for the customers who want the product urgently.

There is also an issue related to lack of information. Although, the user/member can search almost everything on google but the user may still be unable to find some specific detail certain to some specific location, such as, a specific item they want or a band concert in the suburb or some amazing but not so famous coffee shops in the town.

Therefore, there is a need for improved methods and systems to facilitate a user/member to procure products and information from one or more user/members (sellers) in the vicinity of the user that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope. For the purpose of clarity the terms of “user’, “member”, “seller”, “buyer” may be used interchangeably based on the specific circumstance or process flow.

According to some embodiments, a method to facilitate a user to procure products or information from one or more sellers in the vicinity of the user, is disclosed.

Accordingly, the method may include a step of receiving, using a communication device, an indication of demand for a product or information from a buyer device. Further, the method may include a step of receiving, using the communication device, a geographical location of the buyer device. Further, the method may include a step of receiving, using the communication device, a search radius from the buyer device.

Further, the method may include a step of Identifying, using a processing device, one or more seller devices based on the indication of the product or information, the geographical location and the search radius. Further, the method may include a step of transmitting, using the communication device, a request comprising the indication of the product or information to one or more seller devices within the search radius. Further, the method may include a step of receiving, using the communication device, a confirmation of availability of the product or information from one or more seller devices. Further, the method may include a step of transmitting, using the communication device, the list of one or more seller locations to the buyer device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 shows a flowchart of a method to facilitate a user to procure products or information from one or more sellers in the vicinity of the user, in accordance with some embodiments.

FIG. 3 shows a flowchart of a method to facilitate the user to procure query from one or more users in the vicinity of the user, in accordance with some embodiments.

FIG. 4 shows a flowchart of a method to facilitate the processing of an online token based on the user rating, in accordance with some embodiments.

FIG. 5 shows a flowchart of a method to facilitate the determination of one or more seller devices based on the association between user profile and product or information category, in accordance with some embodiment.

FIG. 6 is a sequence diagram illustrating the purchase of the product within a search radius from one or more seller devices, in accordance with an exemplary embodiment.

FIG. 7A shows a user interface representing the real-time geographical location of the user on the map interface, in accordance with an exemplary embodiment.

FIG. 7B shows the user interface representing the buyer indicating the product or information specification along with the search radius, in accordance with an exemplary embodiment.

FIG. 8A shows the user interface representing the real-time geographical location of the user on the map interface, in accordance with an exemplary embodiment.

FIG. 8B shows the user interface representing the seller indicating the product or information specification along with the search radius, in accordance with an exemplary embodiment.

FIG. 9A shows the user interface representing real-time geographical location of buyers and one or more sellers on a map interface, in accordance with an exemplary embodiment.

FIG. 9B shows the user interface representing the bid offer from one or more seller devices, in accordance with an exemplary embodiment.

FIG. 10 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating a user to procure products from one or more sellers in the vicinity of the user, embodiments of the present disclosure are not limited to use only in this context.

In embodiments, a system is provided and may comprise an online platform hosted on a centralized server and accessible via a computing device and at least one first device in communication with at least one of the online platform and the computing device over at least one first communication network, wherein the at least one first device is selected from at least one first mobile device and at least one first electronic device. The system may also comprise at least one second device in communication with at least one of the online platform and the computing device over at least one second communication network, wherein the at least one second device is selected from at least one first mobile device and at least one first electronic device. Moreover, the system may comprise at least one software application stored in and executable by the at least one first device and the at least one second device, wherein the at least one software application is compatible with the computing device such that the online platform creates and processes at least one query based on geographical locations of the at least one first device and the at least one second device corresponding to a search radius starting from a first geographical location of the at least one first device, wherein the search radius is inputted into the at least one software application via the at least one first device.

In an embodiment, the centralized server may be a cloud computing service.

In an embodiment, the at least one first mobile device and the at least one second mobile device may be selected from at least one smartphone, at least one laptop, and at least one tablet computer.

In an embodiment, the at least one first electronic device and the at least one second electronic device may be selected from at least one desktop computer and at least one server computer.

In an embodiment, the at least one software application may be a web-based browser or a web-based software application select from at least one website, at least one web application, at least one desktop application, and at least one mobile application.

In an embodiment, the at least one first communication network and the at least one second communication network may comprise the Internet.

In an embodiment, the system may comprise one or more GPS-powered devices configured to track a real-time geographical location of the at least one first device and the first geographical location of the at least one first device is the real-time geographical location tracked by the one or more GPS-powered devices.

In an embodiment, the first geographical location of the at least one first device may be a different geographical location than a live geographical location of the at least one first device.

In embodiments, a method is provided that may receive, at a computing device, an indication of demand related to one or more categories from a first device over a communication network. The method may receive, at the computing device, a first geographical location of the first device over the communication network, receive, at the computing device, a search radius from the first device over the communication network, wherein the search radius is based on and defined by the first geographical location of the first device, and identify, using the computing device, at least two second devices based on the received indication of demand, the received first geographical location of the first device, and the received search radius. Additionally, the method may transmit, using the computing device and the communication network, requests to the at least two second devices within the received search radius, wherein the requests comprise the received indication of demand, receive, at the computing device, a confirmation from at least one second device of the at least two second devices over the communication network, and transmit, using the computing device and the communication network, a list to the first device, wherein the list comprises a location of the at least one second device. Moreover, the method may display, at the first device, one or more distances between the first device and the at least one second device.

In an embodiment, the method may further comprise storing information in an online platform hosted on a centralized server and accessible via the computing device, wherein the information is associated with or based on at least one selected from the first device, the received indication of demand, the received first geographical location of the first device, the received search radius, the at least two second devices, the confirmation from the at least one second device, the list, the location of the at least one second device, and the at least one second device.

In an embodiment, the method may further comprise adding, using the computing device, the first device to the list to provide an updated list, and transmitting, using the computing device and the communication network, the updated list to a third device.

In an embodiment, the first geographical location of the first device may be a real-time geographical location of the first device.

In an embodiment, the method may further comprise tracking, using one or more GPS-powered devices, the real-time geographical location of the first device.

In an embodiment, the indication of demand may be a query comprising an image inputted or uploaded by or at the first device.

In an embodiment, the indication of demand may be a query provided by an artificial intelligence platform.

In an embodiment, the method may further comprise generating, at the computing device, one or more online tokens for the at least one second device based on a rating of the at least one second device received from the first device.

In an embodiment, the method may further comprise receiving a reward based on a generated amount of the one or more online tokens.

In an embodiment, the method may further comprise transmitting, using the computing device, the generated one or more online tokens to an online account associated with the at least one second device.

In an embodiment, the first device may be selected from at least one first mobile device and at least one first electronic device.

In embodiments, the present disclosure is directed to a mobile software application and/or website (herein referred to as “The Genie”) that allows a member (A) to post something to purchase from another member (B) or ask a question for an answer from another member. The member (A) will receive responses from other members, within a locally defined radius (i.e. a few miles) with either the item member (A) may be looking to purchase with a price or the answer to the question (nominal fee or points system). This may be a consumer to consumer or person to person engagement.

Members of the Genie application may be buyers or sellers or both, asking questions and/or supplying answers or both. The Genie may have a group of components that are necessary for it to work effectively. The components may include a mobile software application on a smartphone or a website (as long as the user have location services turned on) so it knows the location of the user, needs financial information to pay for items purchased and an account (or link to an account) to keep the money the user make when the user sells something. Requires acknowledgement receipt of an item (proof of delivery) to complete the transaction. Genie may have a membership community, so the user has to join to be part of the buying or selling and/or exchange of information. The mobile software application needs GPS so it knows the location of the user and it needs similar financial systems as listed above.

Genie displays what sellers have to offer based on the ask and the price. Sellers cannot see what other sellers are offering and thus it may not be an auction or reverse auction type of process. The process may not be about finding solely the lowest price. The invention is more linked to the location and the item or something close to the item that is asked for. Further, the buyer may be a user/member of the system interested in purchasing a product and/or querying for information from another user/member. The seller may be the user/member of the system with the available product and/or response to the query.

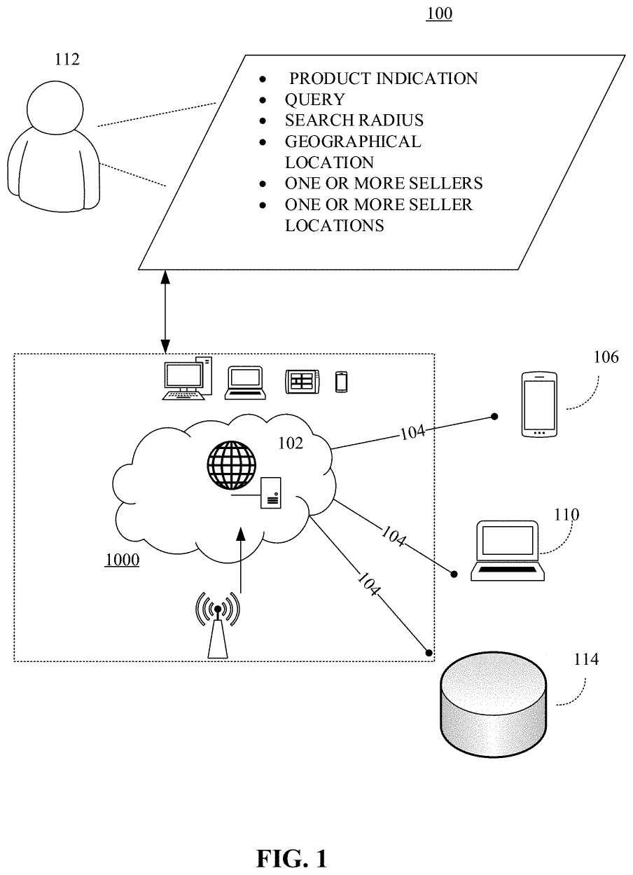

FIG. 1 is an illustration of an online platform 100 consistent with various embodiments of the present disclosure. By way of non-limiting example, the online platform 100 to facilitate the creation and processing of an online purchase and/or a query based on a user location corresponding to a search radius may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), and databases 114 over a communication network 104, such as, but not limited to, the Internet. Further, users of the online platform 100 may include relevant parties such as, but not limited to, end users, e-commerce customer, sellers, buyers and administrators. Accordingly, in some instances, electronic devices operated by the one or more relevant parties may be in communication with the online platform 100.

A user 112, such as the one or more relevant parties, may access the online platform 100 through a web based software application or browser. The web based software application may be embodied as, for example, but not be limited to, a website, a web application, a desktop application, and a mobile application compatible with a computing device 1000.

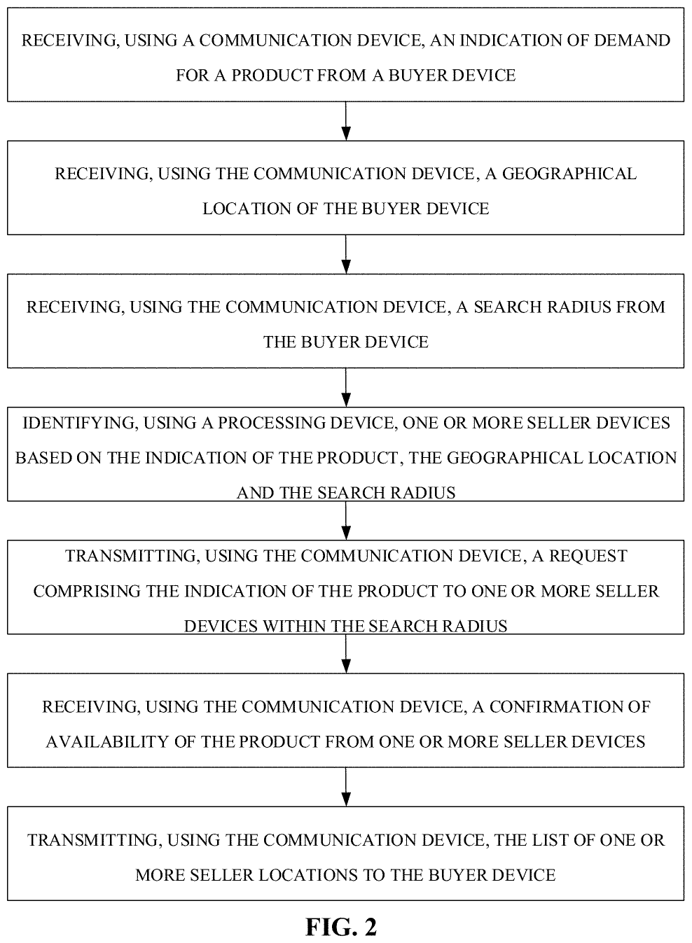

FIG. 2 shows a flowchart of a method to facilitate a user to procure products from one or more sellers in the vicinity of the user, in accordance with some embodiments. Further, the method may include a step of receiving, using a communication device, an indication of demand for a product from a buyer device. Accordingly, the product may include one or more items related to one or more categories such as, but not limited to, electronic gadgets, fashion clothing, healthcare products, sports accessories, cars, motor vehicles, and so on. Further, the electronic gadgets may include one or more, but not limited to, feature phone, smartphone, tablet, laptop computer, desktop computer, smart home devices, wearable computers etc. The user device may include one or more, but not limited to, smartphone, tablet, laptop computer, desktop computer, and so on. Further, the indication may also include specification of the product such as, but not limited to, product name, product category, product image, product brand and so on. Accordingly, for a product such as a mobile phone, the product category may be an electronic device, product name may be an iPhone® and the brand may be Apple®. Further, the indication may include the name of the product among one or more categories.

Further, in one embodiment, the buyer may input the product category rather than the specific product name. For instance, the user may input “Cars” rather than inputting a specific car model and/or name.

Further, in another embodiment, the user may input an image of the product as an indication. Accordingly, the user may take a picture of an item or used an already saved picture and may upload it as an indication of the product.

Further, in another embodiment, the buyer may use AI platforms such as, but not limited to, Alexa®, Bixby®, Google® Assistant, Siri®, and so on to be used as an indication of the product. For instance, the user may say ‘Hey Siri! I would like to buy a mobile device’ and the indication may be the intent of buying a mobile device.

Further, the method may include the step of receiving, using the communication device, a geographical location of the user device. Accordingly, the real-time geographical location may be tracked using one or more GPS powered devices, such as, but not limited to, mobile devices, desktop computer, laptop computer, wearable devices, and so on.

Further, in one embodiment, the user may use a different location rather than the live location. For instance, if the user may be planning to visit ‘New York’ and the user current location is in Chicago, then, the user may use New York as the user location.

Further, the method may include a step of receiving, using the communication device, search radius from the buyer device. Accordingly, the search radius may be defined as the circle having user location as the center and the radius may be determined by the user. The search radius may start from user location and the end limit may go as low as 5 miles and may go as high as 100 miles and more.

Further, the method may include a step of identifying, using a processing device, one or more seller devices based on the indication of the product, the geographical location and the search radius. Accordingly, the one or more seller devices may be selected based on the search radius selected by the buyer device and the product in demand.

Further, in one embodiment, the seller devices may be selected on the basis of seller user profile. Accordingly, if the buyer may be looking for an ‘electronic device’ then only the seller device profile associated with the electronic devices may be selected from the search radius.

Further, in another embodiment, the buyer may also decide the ethnicity of the seller. For instance, if the buyer is interested in the product associated with a specific ethnicity such as a Japanese katana, then, only the seller devices corresponding to the Japanese ethnicity within the search radius may be selected.

Further, the method may include a step of transmitting, using the communication device, a request comprising the indication of the product to one or more seller devices within the search radius. Accordingly, the request for the product in demand may be transmitted to the one or more seller devices selected within the search location along with the product specifications. Further, the product specification may include information such as, but not limited to, product name, product category, product image, product brand and so on. Accordingly, for the product such as a mobile phone, the product category may be an electronic device, product name may be an iPhone® and the brand may be Apple®. Similarly, the specifications may be provided for the products of other categories.

Further, the method may include a step of receiving, using the communication device, a confirmation of availability of the product from one or more seller devices. Accordingly, if the seller may not have the product in demand then the seller device may notify the server of the unavailability of the product. Further, if the seller may have the product then the seller device may notify the server about the availability of the product.

Further, in one embodiment, if the seller may not have the exact product but a different yet similar product, then the seller may transmit the details of the similar product along with the bid amount. For instance, if the buyer may be looking for football cleats of a particular brand but the seller has football cleats but from a different brand. Then, the seller may participate by sharing the image and specifications of the product along with the bid amount.

Further, the method may include a step of transmitting, using the communication device, the list of one or more seller locations to the buyer device. Accordingly, the list of the available products, as well as the location of the one or more seller devices, may be displayed to the buyer device. Further, the list may include one or more, but not limited to, seller details, product name, product specification, and so on.

Further, the distance of the one or more seller devices from the buyer device may be displayed on the buyer user device. Accordingly, the buyer may decide whom to purchase the product from based on not only the price of the product but also the distance of the seller's user device. For instance, if a seller device is offering the product for 50$ but is 10 miles away from the buyer device but another seller device is offering the product for 52$ and is 2 miles away from the buyer device, then, the buyer has the liberty to choose from the provided options based on the urgency of the product.

Further, in one embodiment, whenever the buyer device purchases a specific product then the buyer device may be displayed among one or more seller devices when a second buyer device transmits the indication of the same product within the search radius. Accordingly, the buyer device may sell the product to the second buyer device at a same and/or different price if interested. This may make finding one or more seller devices convenient as the server may know they already have the product.

Further, in some embodiment, the one or more seller devices may be decided based on an online purchase from an online commercial platform. The first buyer purchases the product from on online commercial platform, such as Amazon® and the purchase may be stored in a user profile of the first buyer. Accordingly, whenever the second buyer indicates the interest for the similar product, the system may query through the one or more user profiles of one or more first buyers' profiles. Further, a potential connection to retailers such as Amazon® may also exist to link purchase behavior to searches for buyers request for a specific product and/or information.

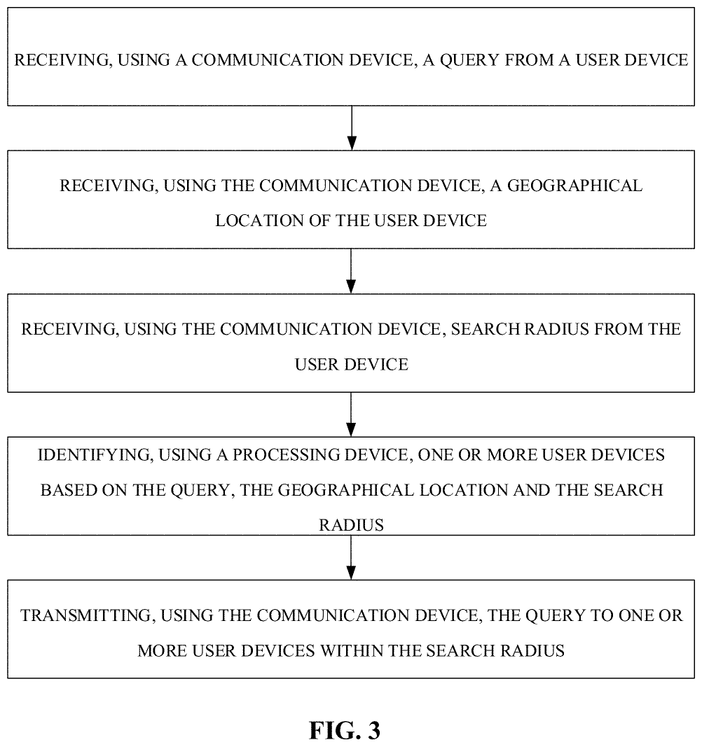

FIG. 3 shows a flowchart of a method to facilitate a user to procure query from one or more users in the vicinity of the user, in accordance with some embodiments. Further, the method may include a step of receiving, using a communication device, a query from a user device. Accordingly, the query may relate to one or more topics such as, but not limited to, live concerts, restaurants, local fairs, activities, how to do something or general information and so on. Further, the user device and/or the communication device may include one or more, but not limited to, feature phone, smartphone, tablet, laptop computer, desktop computer, smart home devices, wearable computers etc. The user device may include one or more, but not limited to, smartphone, tablet, laptop computer, desktop computer, and so on.

Further, in another embodiment, the user may input an image as query. Accordingly, the user may upload the picture and may ask any query based on the information of the picture. For instance, the picture may be a poster of a live concert and the user query may be based on the artists performing in the concert.

Further, in another embodiment, the buyer may use AI platforms such as, but not limited to, Alexa®, Bixby®, Google® Assistant, Siri®, and so on to ask a particular query.

Further, in another embodiment, the user may determine the amount of time for the query to be displayed. Accordingly, one or more seller devices may respond to the query within the specific amount of time which may be an immediately (in most cases), a couple of hours and/or a few days.

Further, the method may include the step of receiving, using the communication device, a geographical location of the user device. Accordingly, the real-time geographical location may be tracked using one or more GPS powered devices, such as, but not limited to, mobile devices, desktop computer, laptop computer, wearable devices, and so on.

Further, in one embodiment, the user may use a different location rather than the live location. For instance, if the user may be planning to visit ‘New York’ and the user current location is in Chicago, then, the user may use New York as the user location. Accordingly, the user may enquire about any event or activity going on in New York while being in Chicago.

Further, the method may include a step of receiving, using the communication device, search radius from the buyer device. Accordingly, the search radius may be defined as the circle having user location as the center and the radius may be determined by the user. The search radius may start from user location and the end limit may go as low as 5 miles and may go as high as 100 miles and more. For instance, the user might want to know about any live concert going on or about the best restaurants within an area, then, the user may set the search radius as 10 miles such that only users within 10 miles may answer the query.

Further, the method may include a step of identifying, using a processing device, one or more user devices based on the query, the geographical location and the search radius. Accordingly, the one or more user devices may be selected based on the query, the geographical location and the search radius.

Further, in one embodiment, the user devices may be selected on the basis of the user profile. Accordingly, if the query is related to an ‘electronic device’ then only the user profile associated with the electronic devices may be selected from the search radius to answer the query.

Further, the method may include the step of transmitting, using the communication device, the query to one or more user devices within the search radius. Accordingly, the query is thus transmitted to one or more user devices identified within the search radius.

Further, in one embodiment, the one or more user device may remain anonymous and answer the query. Accordingly, the one or more user devices may keep their profile hidden and respond to the query.

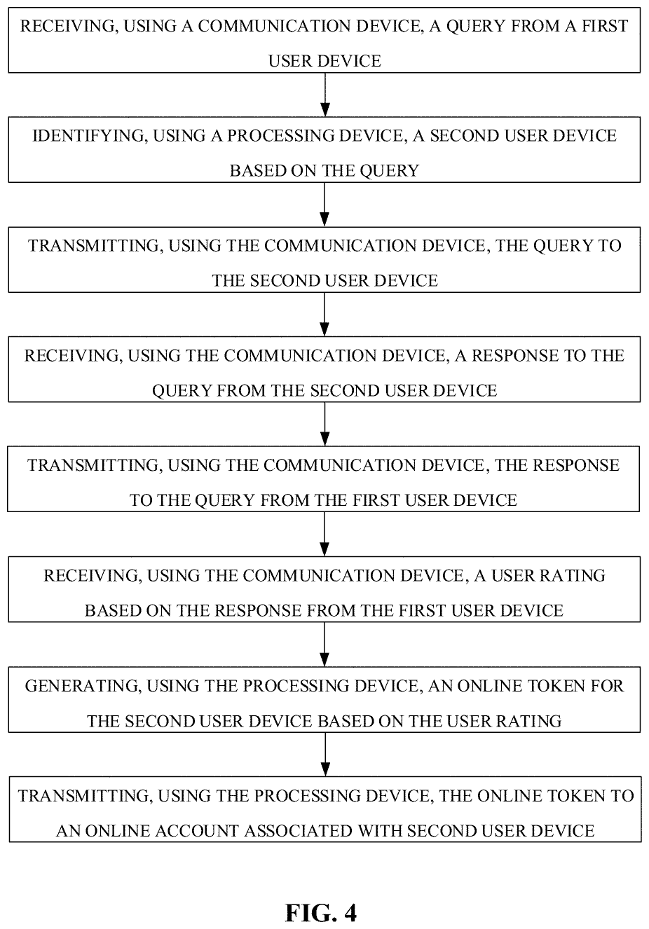

FIG. 4 shows a flowchart of a method to facilitate the processing of an online token based on a user rating, in accordance with some embodiments. Further, the method may include a step of receiving, using a communication device, a query from a first user device. Accordingly, the first user device may be the person asking for a query. Accordingly, the query may relate to one or more topics such as, but not limited to, electronic gadgets, fashion clothing, healthcare products, sports accessories, cars, motor vehicles, live concerts and so on.

Further, in another embodiment, the first user device may input an image as a form of query. Accordingly, the user may upload the picture and may ask any query based on the information of the picture. For instance, the picture may be a poster of a live concert happening in the vicinity of user geographical location and the user query may be related to the artists performing in the concert.

Further, in another embodiment, the first user device may use an AI platform such as, but not limited to, Alexa®, Bixby®, Google® Assistant, Siri®, and so on to ask a particular query. Further, in another embodiment, the user may determine the amount of time for the query to be displayed. Accordingly, one or more seller devices may respond to the query within the specified amount of time which may be a couple of hours and/or a few days.

Further, the method may include a step of identifying, using a processing device, a second user device based on the query. Accordingly, the second user device may be selected based on the search radius, the geographical location of the first user device and the query.

Further, in one embodiment, the second user device may be selected on the basis of the user profile. Accordingly, if the query is related to a category such as ‘electronic devices’ then, only the user profile associated with the electronic devices may be selected within the search radius to answer the query.

Further, the method may include a step of transmitting, using the communication device, the query to the second user device. Accordingly, the query is thus transmitted to the identified second user device based on the search radius, the geographical location of the first user device and the query.

Further, in one embodiment, the second user device may remain anonymous and answer the query. Accordingly, the one or more user devices may keep their profile hidden while responding to a specific query.

Further, the method may include a step of receiving, using the communication device, a response to the query from the second user device. Accordingly, the response may include answering to the particular query. For instance, if the first user had a query about upcoming live concerts within a radius of 20 miles from the first user geographical location. The response may be a list of all upcoming live concert with some specific details such as artists performing, concert timing, and so on.

Further, the method may include a step of transmitting, using the communication device, the response to the query from the first user device. Accordingly, the response to the specific query may be transmitted to the buyer device.

Further, in one embodiment, the response may be received on an AI platform of the user. The AI platform may include one more among, but not limited to, Alexa®, Bixby®, Google® Assistant, Siri®, and so on. The AI platform may thus use audio device such as a speaker and may present the response to the user.

Further, the method may include a step of receiving, using the communication device, a user rating based on the response from the first user device. Accordingly, the first user may rate the response out of 5 based on the satisfaction of the query response.

Further, the user rating of 5 depicts complete satisfaction whereas the user rating of 0 and/or 1 depicts no satisfaction at all.

Further, the method may include a step of generating, using the processing device, an online token for the second user device based on the user rating. Accordingly, based on the user rating, the online tokens may be generated. Online tokens may be visualized as an online currency and once the user gets a certain amount or number of online tokens, the user may receive a reward.

Further, the method may include a step of transmitting, using the processing device, the online token to an online account associated with the second user device. Accordingly, the online account associated with the second user device may include one or more, but not limited to, PayPal®, credit and/or debit card details, online net banking, and so on.

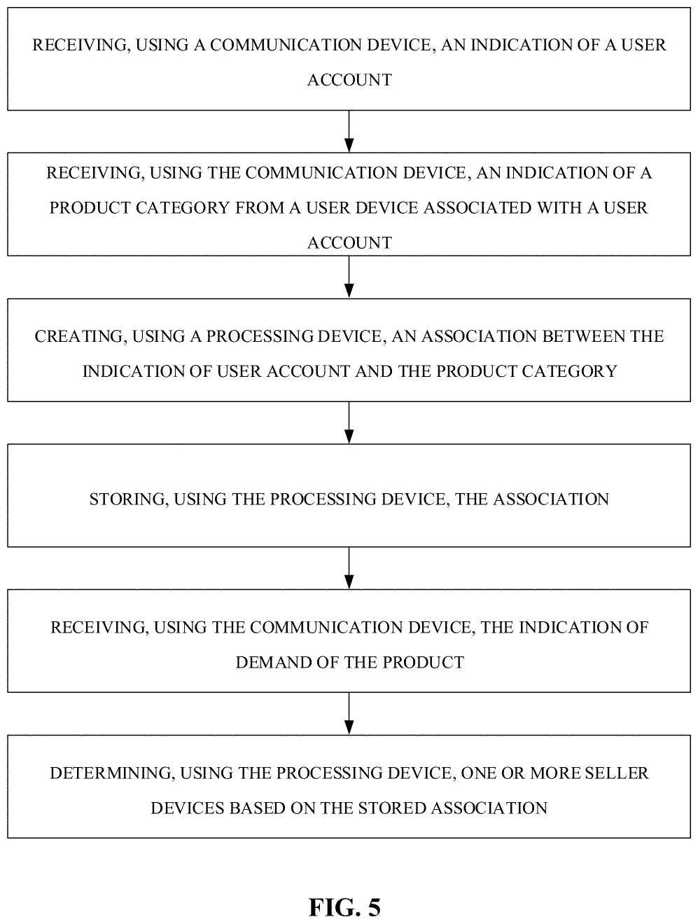

FIG. 5 shows a flowchart of a method to facilitate the determination of one or more seller devices based on an association between user profile and product category, in accordance with some embodiment. Further, the method may include a step of receiving, using a communication device, an indication of a user account. Accordingly, the indication may include information such as, but not limited to, username, age, gender, banking accounts, and so on.

Further, in one embodiment, the user may also link the social media platform such as, but not limited to, Facebook®, Gmail®, Yahoo®, and so on. Accordingly, the personal information may be extracted from the linked social media platforms.

Further, the method may include a step of receiving, using the communication device, an indication of a product category from the user device associated with the user account. Accordingly, the product category may include one or more categories such as, but not limited to, electronic gadgets, fashion clothing, healthcare products, sports accessories, cars, motor vehicles, and so on. Further, the electronic gadgets may include one or more, but not limited to, feature phone, smartphone, tablet, laptop computer, desktop computer, smart home devices, wearable computers etc. Further, the indication of the product may correspond to the product category based on the user interest.

Further, in one embodiment, the user may select one or more product category from the provided categories. Accordingly, the user might be interested in sports as well as motor vehicles so the user may select both the categories. The user may also select another product category to create a diverse list of the interested product category. Further, the method may include a step of creating, using a processing device, an association between the indication of user account and the product category. Accordingly, the association may be created to make sure that a particular product category corresponds to a specific user account.

Further, the method may include a step of storing, using the processing device, the association. Accordingly, the association between the product category and the user account may be saved in the online platform.

Further, in one embodiment, the stored association may be protected by a user identifier such that only the user may access the stored association. Accordingly, the user identifier may be a self-generated passcode which may also be presented to the user. The user may also set-up a password to access the stored association.

Further, the method may include a step of receiving, using the communication device, the indication of the product. Accordingly, the product may include one or more items related to one or more categories such as, but not limited to, electronic gadgets, fashion clothing, healthcare products, sports accessories, cars, motor vehicles, and so on. Further, the electronic gadgets may include one or more, but not limited to, feature phone, smartphone, tablet, laptop computer, desktop computer, smart home devices, wearable computers etc. The user device may include one or more, but not limited to, smartphone, tablet, laptop computer, desktop computer, and so on. Further, the indication may also include specification of the product such as, but not limited to, product name, product category, product image, product brand and so on.

Further, the method may include a step of determining, using the processing device, one or more seller devices based on the stored association. Accordingly, based on the association stored in the online platform, one or more seller devices may be selected associated with the product in demand. For instance, if the product in demand may be a gaming console, then the online platform may extract all user profile associated with the gaming console and automatically transmit the product request to the associated user profile device.

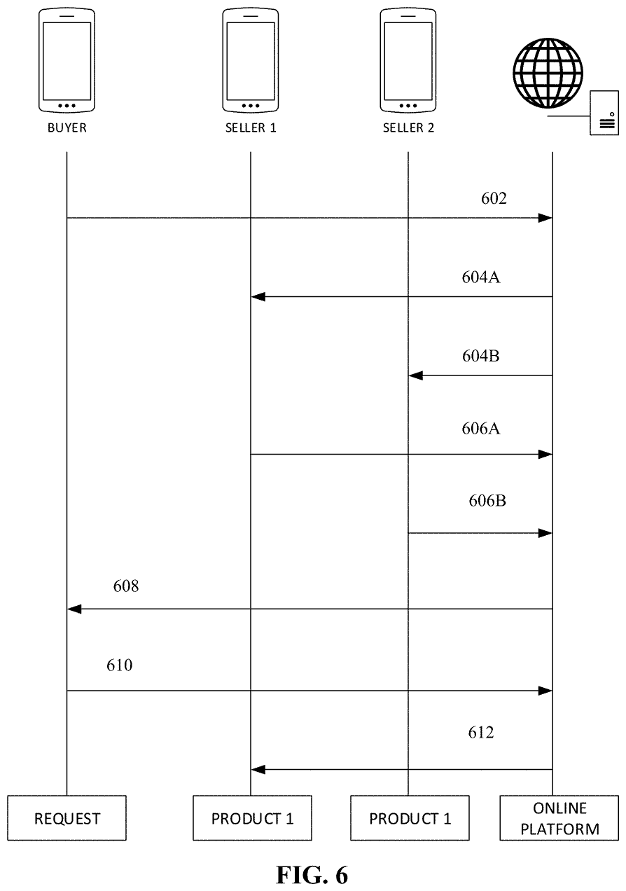

FIG. 6 is a sequence diagram illustrating the purchase of a product within a search radius from one or more seller devices, in accordance with an exemplary embodiment. At 602, the online platform receives a request from the buyer consisting of an indication of the product. Further, the indication may include specification of the product such as, but not limited to, product name, product category, product image, product brand and so on.

Further, based on the buyer device geographical location and the search radius determined by the buyer, the online platform may find one or more seller devices within the search radius. 604A and 604B depict the online platform transmitting the buyer request to seller device 1 and seller device 2 respectively. Seller device 1 and seller device 2 may be inside the search radius determined by the buyer device. At 606A, the online platform receives the confirmation of availability of Product 1 from seller device 1. Accordingly, the seller device 1 may transmit ‘Yes’ along with the bid amount if the seller is ready to sell the product in demand. Similarly, seller device 2 may follow the same and transmit the availability response for Product 1 to the online platform.

Further, in one embodiment, if the seller may not have the exact product but a different yet similar product, then the seller may transmit the details of the similar product along with the bid amount. For instance, if the buyer may be looking for football studs of a particular brand but the seller has football studs but from a different brand. Then, the seller may participate by sharing the image and specifications of the product along with the bid amount. At 608, the online platform transmits the list of available products along with one or more seller device locations to the buyer device. The one or more seller device locations may contain information related to exactly how far each seller device may be from the user device. At 610, the buyer device may decide among the list of one or more seller devices and transmit the choice to the online platform. The choice may not be based only on the minimum cost but may also depend on the distance of one or more seller devices from the buyer device. For instance, if a seller device is offering the product for 52$ but is 2 miles away from the buyer device but another seller device is offering the product for 50$ and is 10 miles away from the buyer device, then, the buyer has the liberty to choose from the provided options based on the urgency of the product. At 612, the online platforms transmit the order confirmation from the buyer device to the seller device 1. Accordingly, the distance may also play a major role while deciding among one or more seller devices for the specific product in demand.

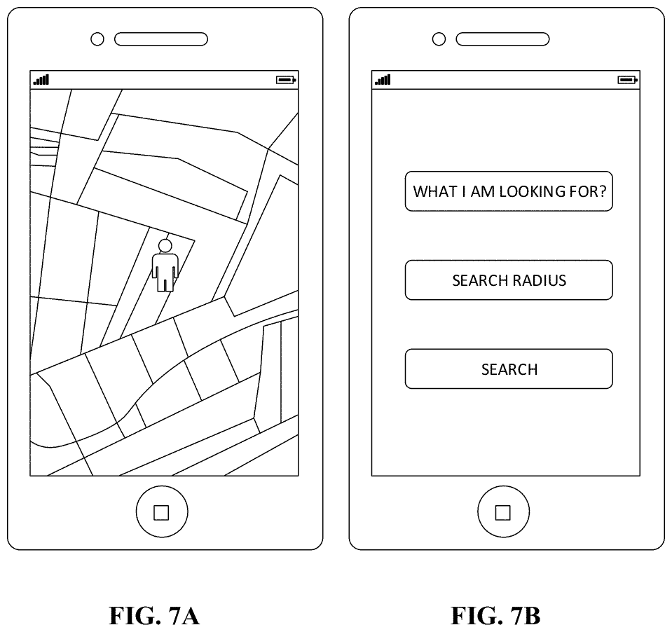

FIG. 7A shows a user interface representing the real-time geographical location of a user on the map interface, in accordance with an exemplary embodiment. Accordingly, the real-time geographical location may be tracked using one or more GPS powered devices, such as, but not limited to, mobile devices, desktop computer, laptop computer, wearable devices, and so on.

Further, in one embodiment, the user may use a different location rather than the live location. For instance, if the user may be planning to visit ‘New York’ and the user current location is in Chicago, then, the user may use New York as the user location.

FIG. 7B shows the user interface representing the buyer indicating the product specification along with a search radius, in accordance with an exemplary embodiment. Accordingly, the buyer may input the product specification in the “What I am looking for?” box. The product specification may include information such as, but not limited to, product name, product category, product image, product brand and so on. Further, the buyer may set up the search radius. Accordingly, the search radius may be defined as the circle having user location as the center and the radius may be determined by the user. The search radius may start from user location and the end limit may go as low as 5 miles and may go as high as 100 miles and more. Further, when the user clicks on “Search”, the user-interface may display one or more seller devices based on the product in demand and user geographical location and the search radius.

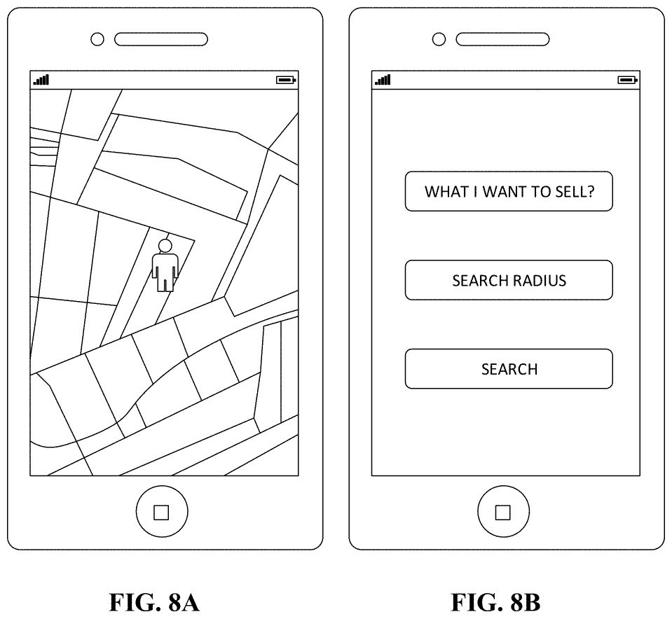

FIG. 8A shows the user interface representing the real-time geographical location of a user on the map interface, in accordance with an exemplary embodiment. Accordingly, the real-time geographical location may be tracked using one or more GPS powered devices, such as, but not limited to, mobile devices, desktop computer, laptop computer, wearable devices, and so on.

Further, in one embodiment, the user may use a different location rather than the live location. For instance, if the user may be planning to visit ‘New York’ and the user current location is in Chicago, then, the user may use New York as the user location. FIG. 8B shows the user interface representing the seller indicating the product specification along with the search radius, in accordance with an exemplary embodiment. Accordingly, the seller may input the product specification of the product that is of interest to the seller in the “What I want to sell?” box. Further, the seller may set up a search radius. Accordingly, the search radius may be defined as the circle having user location as the center and the radius may be determined by the user. The search radius may start from user location and the end limit may go as low as 5 miles and may go as high as 100 miles and more. Further, when the user clicks on “Search”, the user-interface may display one or more buyer devices based on the product in demand and user geographical location and the search radius.

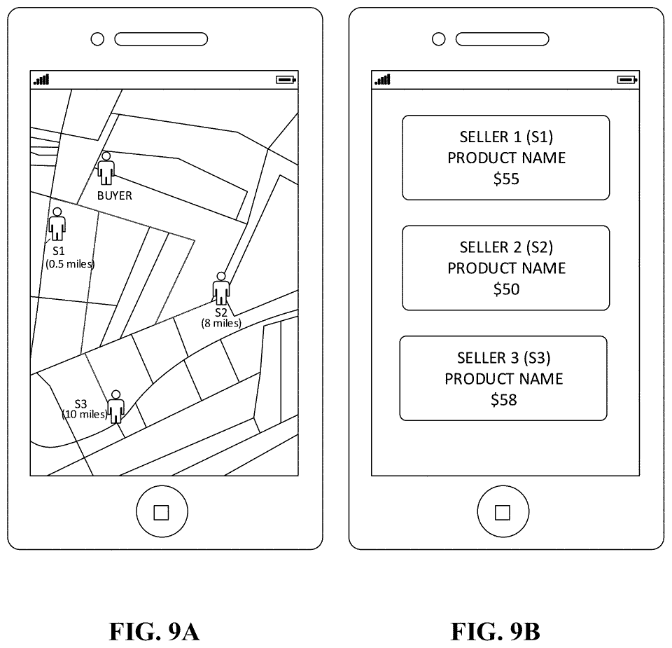

FIG. 9A shows the user interface representing real-time geographical location of buyers and one or more sellers on a map interface, in accordance with an exemplary embodiment. Accordingly, the real-time geographical location may be tracked using one or more GPS powered devices, such as, but not limited to, mobile devices, desktop computer, laptop computer, wearable devices, and so on. Further, the map illustrates the distance of each seller device from the buyer device. The interface shows three sellers, S1, S2 and S3 and the distance of each seller device from the buyer device. Further, the possible route between the buyer device and each of the seller devices may also be presented.

Further, in one embodiment, the road traffic between the buyer and one or more seller devices may also be presented. Accordingly, an average time for the journey between the buyer and one or more seller devices may also be presented.

FIG. 9B shows the user interface representing the bid offer from one or more seller devices, in accordance with an exemplary embodiment. Further, the bid offer from all three seller devices may be presented to the buyer device. The buyer may then choose from the one or more offers made by one or more seller devices. The buyer has the liberty to choose from the provided options based on the urgency of a product. The product may include one or more items related to one or more categories such as, but not limited to, electronic gadgets, fashion clothing, healthcare products, sports accessories, cars, motor vehicles, and so on. Accordingly, if the buyer requires the product urgently then the buyer may buy the product from seller 1 who is only half mile away from the buyer device.

Further, in one embodiment, the user/member may procure the one or more products based on the availability of a ride service. Accordingly, the method may include a step of receiving, using a communication device, an indication of demand for a product or information from a buyer device. The indication of the product may include one or more items related to one or more categories such as, but not limited to, electronic gadgets, fashion clothing, healthcare products, sports accessories, cars, motor vehicles, and so on. Further, the method may include a step of receiving, using the communication device, a geographical location and a search radius of the buyer device. The real-time geographical location may be tracked using one or more GPS powered devices, such as, but not limited to, mobile devices, desktop computer, laptop computer, wearable devices, and so on. Further, the method may include a step of identifying, using a processing device, one or more seller devices based on the indication of the product, the geographical location and the search radius. The one or more seller devices may be identified within the search radius which may be decided by the buyer. The search radius may be defined as the circle having user location as the center and the radius may be determined by the user. The search radius may start from user location and the end limit may go as low as 5 miles and may go as high as 100 miles and more. Further, the method may include a step to query, using the processing device, a rider service in the vicinity of the one or more seller devices. Accordingly, the system may query through a ride providing service, such as Uber® and procure the list of available riders in the vicinity of one or more seller devices. The ride services may facilitate the delivery of the product from the seller location to the buyer location. Further, the method may include of transmitting, using the communication device, the request of the product and/or the information based on the search radius and the query of the ride service. Accordingly, the request may be transmitted based on the search radius pre-determined by the buyer and the availability of the ride service provider. Accordingly, the request may be sent when the rider belonging to the ride service provider, such as Uber®, may be present in the vicinity of one or more seller devices.

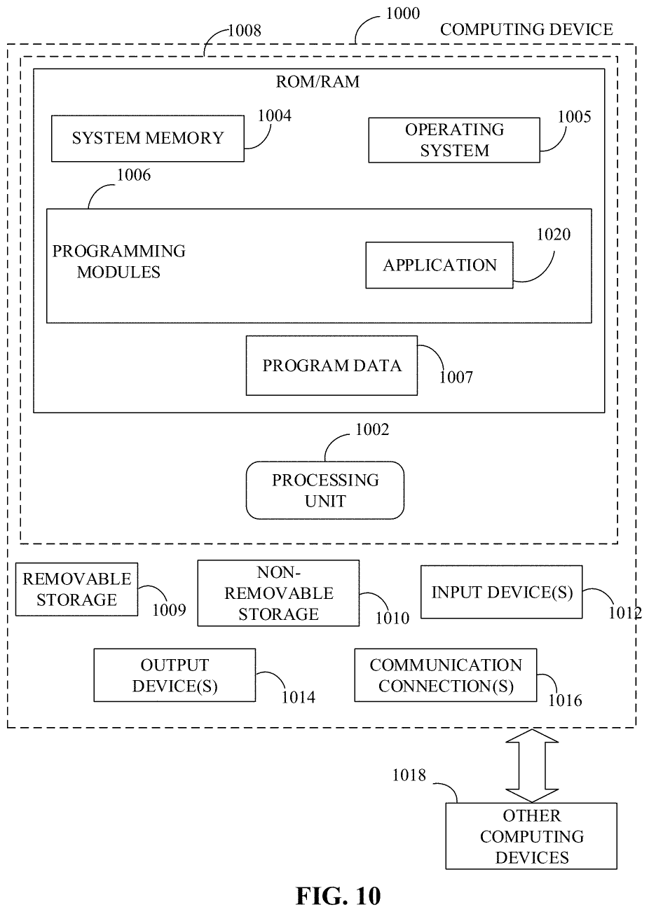

With reference to FIG. 10, a system consistent with an embodiment of the disclosure may include a computing device or cloud service, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation.

In one embodiment, programming modules 1006 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008. Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010.

Computer storage media may include volatile and nonvolatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000.

Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used. Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes. Other programming modules that may be used in accordance with embodiments of the present disclosure may include encoding/decoding applications, machine learning application, classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure. Although the invention has been explained in relation to its preferred embodiment, it is to be understood that many other possible modifications and variations can be made without departing from the spirit and scope of the invention.

What is claimed:

1. A system comprising:
an online platform hosted on a centralized server and accessible via a computing device;
at least one first device in communication with at least one of the online platform and the computing device over at least one first communication network, wherein the at least one first device is selected from at least one first mobile device and at least one first electronic device;
at least one second device in communication with at least one of the online platform and the computing device over at least one second communication network, wherein the at least one second device is selected from at least one first mobile device and at least one first electronic device; and
at least one software application stored in and executable by the at least one first device and the at least one second device, wherein the at least one software application is compatible with the computing device such that the online platform creates and processes at least one query based on geographical locations of the at least one first device and the at least one second device corresponding to a search radius starting from a first geographical location of the at least one first device, wherein the search radius is inputted into the at least one software application via the at least one first device.

2. The system of claim 1, wherein the centralized server is a cloud computing service.

3. The system of claim 1, wherein the at least one first mobile device and the at least one second mobile device is selected from at least one smartphone, at least one laptop, and at least one tablet computer.

4. The system of claim 1, wherein the at least one first electronic device and the at least one second electronic device is selected from at least one desktop computer and at least one server computer.

5. The system of claim 1, wherein the at least one software application is a web-based browser or a web-based software application select from at least one website, at least one web application, at least one desktop application, and at least one mobile application.

6. The system of claim 1, wherein the at least one first communication network and the at least one second communication network comprise the Internet.

7. The system of claim 1, further comprising:
one or more GPS-powered devices configured to track a real-time geographical location of the at least one first device and the first geographical location of the at least one first device is the real-time geographical location tracked by the one or more GPS-powered devices.

8. The system of claim 1, wherein the first geographical location of the at least one first device is a different geographical location than a live geographical location of the at least one first device.

9. A method comprising:
receiving, at a computing device, an indication of demand related to one or more categories from a first device over a communication network;
receiving, at the computing device, a first geographical location of the first device over the communication network;
receiving, at the computing device, a search radius from the first device over the communication network, wherein the search radius is based on and defined by the first geographical location of the first device;
identifying, using the computing device, at least two second devices based on the received indication of demand, the received first geographical location of the first device, and the received search radius;
transmitting, using the computing device and the communication network, requests to the at least two second devices within the received search radius, wherein the requests comprise the received indication of demand;
receiving, at the computing device, a confirmation from at least one second device of the at least two second devices over the communication network;
transmitting, using the computing device and the communication network, a list to the first device, wherein the list comprises a location of the at least one second device; and
displaying, at the first device, one or more distances between the first device and the at least one second device.

10. The method of claim 9, further comprising:
storing information in an online platform hosted on a centralized server and accessible via the computing device, wherein the information is associated with or based on at least one selected from the first device, the received indication of demand, the received first geographical location of the first device, the received search radius, the at least two second devices, the confirmation from the at least one second device, the list, the location of the at least one second device, and the at least one second device.

11. The method of claim 9, further comprising:
adding, using the computing device, the first device to the list to provide an updated list; and
transmitting, using the computing device and the communication network, the updated list to a third device.

12. The method of claim 9, wherein the first geographical location of the first device is a real-time geographical location of the first device.

13. The method of claim 12, further comprising:
tracking, using one or more GPS-powered devices, the real-time geographical location of the first device.

14. The method of claim 9, wherein the indication of demand is a query comprising an image inputted or uploaded by or at the first device.

15. The method of claim 9, wherein the indication of demand is a query provided by an artificial intelligence platform.

16. The method of claim 9, further comprising:
generating, at the computing device, one or more online tokens for the at least one second device based on a rating of the at least one second device received from the first device.

17. The method of claim 16, further comprising:
receiving a reward based on a generated amount of the one or more online tokens.

18. The method of claim 16, further comprising:
transmitting, using the computing device, the generated one or more online tokens to an online account associated with the at least one second device.

19. The method of claim 9, wherein the first device is selected from at least one first mobile device and at least one first electronic device.
